(19) United States
(12) Patent Application Publication
(10) Pub. No.: US 2007/0017489 A1
(43) Pub. Date: Jan. 25, 2007

(54) Gas circulating apparatus

(75) Inventors: Katsuhiro Kuroki, Nagoya-city (JP); Osamu Shimane, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/483,601

(22) Filed: Jul. 11, 2006

(30) Foreign Application Priority Data
Jul. 19, 2005 (JP) 2005-208003

(51) Int. Cl. F02M 25/07

(52) U.S. Cl. 123/568.12; 123/568.18

(57) ABSTRACT

In a gas circulating apparatus, a bypass pipe extends in parallel with an EGR gas cooler. The aperture end of the bypass pipe is inserted to inside of a housing of a valve device and is positioned adjacent to a valve in the housing. Accordingly, the high-temperature EGR gas heat introduced to a second exhaust gas passage of the housing from the bypass pipe is difficult to be transmitted to a first exhaust gas passage of the housing. Thus, the heat transmission of the high-temperature EGR gas to the EGR gas cooler can be reduced.

### CROSS REFERENCE TO RELATED APPLICATION

This application is related to and claims priority from Japanese Patent Application No. 2005-208003 filed on Jul. 19, 2005, the content of which are hereby incorporated by reference.

### BACKGROUND OF THE INVENTION

1. Field of the Invention

The present invention relates to a gas circulating apparatus in which a cooling device is provided in an exhaust gas recirculation pipe (EGR pipe) through which a portion of exhaust gas from an internal combustion engine recirculates into an intake side.

2. Description of Related Art

A conventional gas circulating apparatus includes an EGR pipe for recirculating a portion of an exhaust gas in an internal combustion engine from an exhaust passage to an intake passage, and a water-cooling EGR gas cooler provided in the EGR pipe. The exhaust gas recirculated into the intake passage in the internal combustion engine is cooled in the EGR pipe. The temperature of the exhaust gas is decreased and the volume of the exhaust gas becomes smaller. Accordingly, a combustion temperature can be reduced in the internal combustion engine without lowering an output of the internal combustion engine so that a generation of a NOx can be reduced effectively.

However, if the EGR gas cooler is provided in the EGR pipe, the exhaust gas recirculated to the internal combustion engine is sure to be cooled. Therefore, the warm effect on the intake air is small when the exhaust gas is recirculated in a cold circumstance. Generally, the recirculation of the high-temperature exhaust gas into the intake side of the engine has the effect of warming the intake air. However, in the cold circumstance, the recirculation of the cooled exhaust gas in the EGR water-cooled device to the intake side does not have the sufficient effect for warming the intake air. Accordingly, in the cold circumstance, the possibility of the ignition failure increases in the internal combustion engine and white fuming is easy to generate.

In order to optimize the temperature of the exhaust gas corresponding to an operation state in the internal combustion engine, a gas circulating apparatus having an EGR gas cooler module is suggested (e.g., U.S. Pat. No. 6,141,961). The EGR gas cooler module is provided in an exhaust gas recirculation passage (EGR passage), which recirculates a portion of the exhaust gas in the internal combustion engine (recirculated gas of the exhaust gas: EGR gas) from the exhaust passage to the intake passage. In the EGR gas cooler module shown in FIG. 4, the EGR water-cooled device using engine coolant water is combined with a valve device disposed at the downstream side of the EGR water-cooled device in the flow of the EGR gas. The EGR water-cooled device includes an EGR gas cooler 101 for cooling the EGR gas, and a bypass pipe 102 for bypassing the EGR gas cooler.

The valve device includes: a switching valve 105 which switches between an exhaust gas passage (outlet passage in the cooler) 103 communicating with the inside of the EGR gas cooler 101 and an exhaust gas passage (outlet passage in the bypass pipe) 104 communicating with the inside of the bypass pipe 102; a housing 107 which holds a shaft 106 of the valve 105; and a valve driving device (not shown) which opens or closes the valve 105. The EGR gas cooler 101 and the bypass pipe 102 are disposed in parallel, and the housing 107 is disposed at the downstream side of the EGR gas cooler 101 and the bypass pipe 102 in the flow of the EGR gas. Accordingly, the construction of the EGR gas cooler module can be compact because the EGR gas cooler 101 and the bypass pipe 102 are disposed in parallel. Further, the heat of the exhaust gas can less affect the valve 105 because the housing 107 is disposed at the downstream side of the EGR gas cooler 101 and the bypass pipe 102 in the flow of the EGR gas.

However, as shown in FIG. 4, in the EGR gas cooler module described in U.S. Pat. No. 6,141,961, the exhaust gas passage 103 and the exhaust gas passage 104 are disposed adjacently. Therefore, in a case where a high-temperature exhaust gas is needed, the desired high-temperature gas cannot be obtained. When the exhaust gas cooled by the EGR gas cooler 101 is retained in the exhaust gas passage 103, the heat of the high-temperature gas flowing through the exhaust gas passage 104 is transmitted to the exhaust gas passage 103 through a partition wall 113 of the housing 107. The heat transmission occurs even if an inlet port 111 on the side of the EGR gas cooler 101 is totally closed and an inlet port 112 on the side of the bypass pipe 102 is totally opened.

In order to eliminate above described problem, the cooling ability of the EGR gas cooler 101 may be reduced or an aperture sectional area (passage sectional area) of the bypass pipe 102 may be enlarged. However, this generates a next problem that a desired low-temperature exhaust gas cannot be obtained.

### SUMMARY OF THE INVENTION

In view of the foregoing and other problems, it is an object of the present invention to provide a gas circulating apparatus capable to recirculate a desired high-temperature exhaust gas to an intake passage in an internal combustion engine without reducing a cooling ability of a heat exchanger or enlarging a passage sectional area of a bypass pipe.

According to an example of the present invention, a gas circulating apparatus for circulating an exhaust gas of an internal combustion engine includes a heat exchanger for cooling exhaust gas, a bypass pipe through which an exhaust gas flows while bypassing from the heat exchanger, and a valve device disposed downstream of the heat exchanger and the bypass pipe in an exhaust gas flow. In the gas circulating apparatus, the valve device includes a housing which has a first exhaust gas passage communicating with an inside of the heat exchanger and a second exhaust gas passage communicating with an inside of the bypass pipe, and a valve provided inside of the housing, to open and close the first exhaust gas passage and the second exhaust gas passage. Further, the bypass pipe includes an aperture end from which the exhaust gas flows into the second exhaust gas passage. The aperture end is inserted into the inside of the housing, and is positioned adjacent to the valve.

Accordingly, the heat of the high-temperature exhaust gas introduced from the bypass pipe to the inside of the housing is difficult to be transmitted into the first exhaust gas passage from the second exhaust gas passage. Thus, the heat transmission of the high-temperature exhaust gas to the heat exchanger (first exhaust gas passage) can be decreased. Accordingly, the gas circulating apparatus is able to recirculate a desired high-temperature exhaust gas into the intake passage in the internal combustion engine without reducing the cooling ability of the heat exchanger or enlarging the aperture sectional area of the bypass pipe.

### BRIEF DESCRIPTION OF THE DRAWINGS

The above and other objects, features and advantages of the present invention will become more apparent from the following detailed description made with reference to the accompanying drawings. In the drawings:

FIG. 1 is a cross-sectional view showing a valve device disposed downstream from an exhaust gas cooling device according to an embodiment of the present invention;

FIG. 2 is a schematic view showing an entire structure of a gas circulating apparatus according to the embodiment of the present invention;

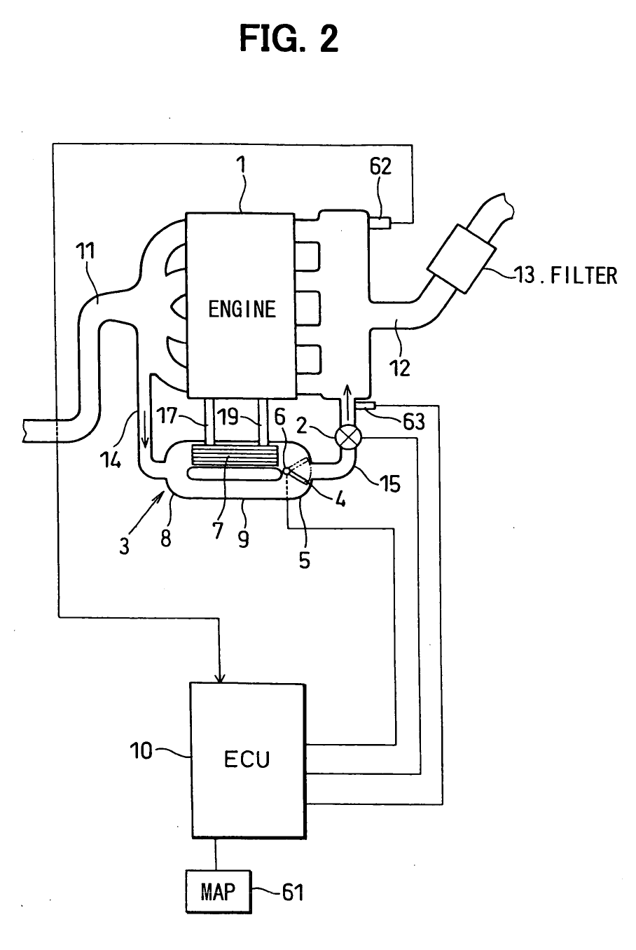

FIG. 3 is a schematic cross-sectional view showing an entire structure of an EGR gas cooler module in which the exhaust gas cooling device and the valve device are combined according to the embodiment of the present invention; and

FIG. 4 is a cross-sectional view showing an entire structure of a conventional EGR gas cooler module with an exhaust gas cooling device and a valve device.

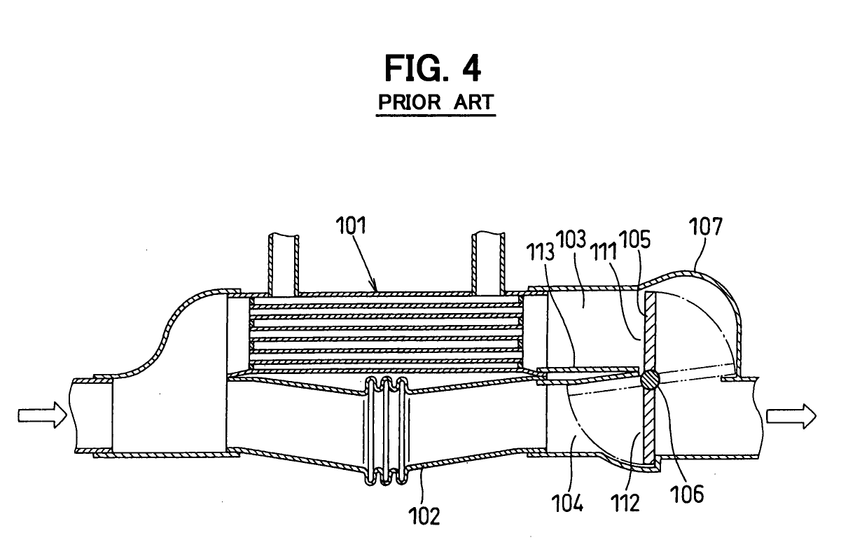

### DETAILED DESCRIPTION OF PREFERRED EMBODIMENTS

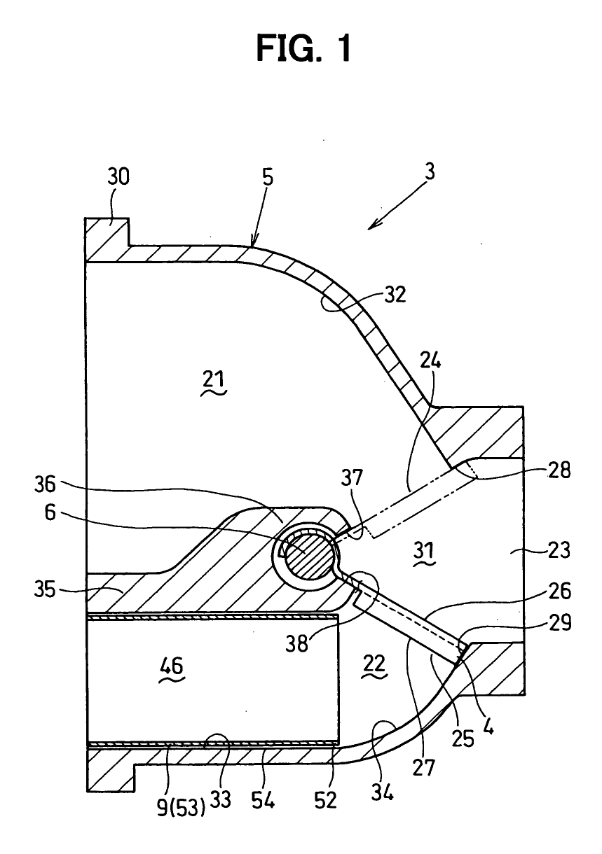

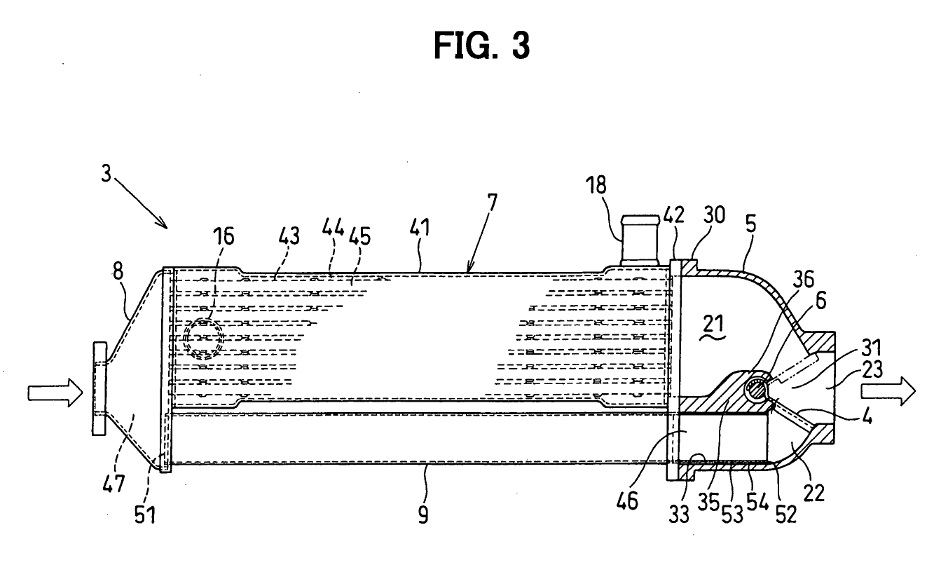

An embodiment of the present invention will be now described with reference to FIG. 1 and FIG. 3. In this embodiment, a gas circulating apparatus is used for an internal combustion engine 1 (hereinafter referred to as “engine”) e.g., a diesel engine. The gas circulating apparatus is connected to an exhaust passage 11 disposed in the engine 1. The gas circulating apparatus includes a recirculation pipe and an EGR control valve 2. The recirculation pipe is provided to recirculate a portion of an exhaust gas from a combustion room in the engine 1 to an intake passage 12 provided in an intake pipe in the engine 1. The EGR control valve 2 adjusts, continuously or stepwise, the amount of a recirculated exhaust gas (hereinafter referred to as “amount of the EGR”) flowing through the exhaust gas recirculation passage provided in the exhaust gas recirculation pipe. Exhaust gas flows along the exhaust passage 11 in the engine 1. Intake air is filtered by an air cleaner 13 and flows along the intake passage 12.

In the exhaust gas recirculation pipe in the embodiment, an EGR gas cooler module 3 is connected with the first and second recirculation pipes 14, 15 directly in series. The EGR gas cooler module is between a first recirculation pipe 14 branched from the exhaust pipe and a second recirculation pipe 15 joined to the intake pipe. The recirculation pipe 14 in this embodiment is connected to an exhaust manifold of the exhaust pipe. The recirculation pipe 15 is connected to an intake manifold or a surge tank of the intake pipe. A coolant water circuit for the engine 1 is provided to supply the engine cooling water to the EGR gas cooler module 3 so that the engine cooling water is recycled. The coolant water circuit includes a first coolant pipe 17, a second coolant pipe 19 and a water pump (not shown). The first coolant pipe 17 supplies the engine cooling water from the water jacket (not shown) in the engine 1 to an inlet pipe in the EGR gas cooler module 3. The second coolant pipe 19 supplies the engine cooling water back from a coolant water outlet pipe 18 in the EGR gas cooler module 3 to the water jacket in the engine 1 through a radiator (not shown). The water pump generates a cycle flow of the engine coolant water in the engine coolant water circuit. In the embodiment, the engine coolant water is heat-exchanged with outside air in the radiator so that the engine coolant water whose temperature is in a desired temperature range (e.g., 75-80° C.) can be supplied back to the water jacket in the engine 1.

The EGR gas cooler module 3 includes an exhaust gas cooling device, an EGR control valve, a part of the exhaust gas recirculation pipe of the gas circulating apparatus, and a part of the coolant pipe of the engine cooling circuit. The exhaust gas cooling device cools the EGR gas by heat-exchanging the high-temperature EGR gas with the engine coolant water. The EGR control valve is disposed downstream from the exhaust gas cooling device in the flow of the EGR gas. The EGR control valve in the embodiment includes a valve driving device having a plate valve 4, a housing 5 and a valve shaft (hereinafter referred to as “shaft”) 6. The plate valve 4 opens and closes a first exhaust gas passage 21 on the EGR gas cooler side and a second exhaust gas passage 22 on the bypass pipe side. The housing 5 has enough space in which the plate valve 4 can open and close easily. The shaft 6 rotates integrally with the plate valve 4. The exhaust gas cooling device includes an EGR gas cooler 7 and a bypass pipe 9. The EGR gas cooler 7 cools the EGR gas passing therethrough. The bypass pipe 9 diverts the EGR gas from the EGR gas cooler 7.

The plate valve 4 in the embodiment is made of metal material having heat and corrosion resistance (e.g., stainless steel), and is disc-shaped. The plate valve 4 includes a plate portion (valve portion) 26 whose one end is fixed and another end is free. The plate portion 26 including the free end is rotated centering on the fixed end, and opens and closes a first valve port 24 and a second valve port 25. The fixed end of the plate valve 4 is formed into a circular arc shape corresponding to the cylindrical circumference of a valve fixing portion of the shaft 6. The fixed end of the plate is fixed at the part of the circumference of the valve fixing portion of the shaft 6 by fixing means (e.g., welding). A side wall 27 is formed on the outer edge of the valve portion 26 integrally in order to promote mixing of the high-temperature gas and the low-temperature gas.

In case almost all the airflow of the EGR gas introduced into the inside of the EGR gas cooler module 3 from the recirculation pipe 14 is let to pass into the bypass side, the valve portion 26 is seated on a first valve seat. The plate valve 4 is controlled to open totally the second valve port 25 by the valve driving device. In case almost all the airflow of the EGR gas introduced into the inside of the EGR gas cooler module 3 from the recirculation pipe 14 is let to pass into the EGR gas cooling device side, a valve clearance between the valve portion 26 and a second valve seat 29 is the smallest. The plate valve 4 is controlled to open totally the first valve port 24 by the valve driving device. That is, even if the second exhaust gas passage 22 is closed totally, a desired clearance between the valve portion 26 of the plate valve 4 and the second valve seat 29 of the housing 5 is formed. Accordingly, the high-temperature EGR gas flows into a valve room 31 from the second exhaust gas passage 22.

The housing 5 in the EGR control valve is disposed, as shown in FIG. 3, at the downstream side of the exhaust gas-cooling device (i.e., the EGR gas cooler 7 and the bypass pipe 9) in the flow of the EGR gas. The housing 5 is formed into a predetermined shape integrally using aluminum cast or aluminum die-cast, and brazed integrally to the EGR gas cooler 7 and the bypass pipe 9. The housing 5 includes a joint pipe in which the low-temperature EGR gas from the EGR gas cooler 7 and the high-temperature EGR gas from the bypass pipe 9 join together and flow into the air intake passage 12 through the exhaust gas recirculation passage 15. On the left edge of the housing 5 in FIG. 3, a joint portion 30 having a flange portion connected to the exhaust gas-cooling device (i.e., the EGR gas cooler 7 and the bypass pipe 9) is provided.

Inside of the housing 5, as shown in FIG. 1 and FIG. 3, the first exhaust gas passage 21, the second exhaust gas passage 22, the valve room (mixing room) 31 and a third exhaust gas passage (outlet side passage) 23 are provided. The EGR gas is introduced to the first exhaust gas passage 21 from the outlet portion of the EGR gas cooler 7. The EGR gas is introduced to the second exhaust gas passage 22 from the outlet portion of the bypass pipe 9. The low-temperature EGR gas which flows from the first exhaust gas passage 21 through the first valve port 24 (inlet port) and the high-temperature EGR gas which flows from the second exhaust gas passage 22 through the second valve port 25 (inlet port) are joined and mixed in the valve room 31. The joined and mixed EGR gas flows from the outlet port of the valve room 31 to the exhaust gas recirculation passage 15 through the third exhaust gas passage 23. The exhaust gas passages 21-23 and the valve room 31 construct a part of the exhaust gas recirculation passage inside of the housing 5.

The first exhaust gas passage 21 is the first passage extending from the aperture portion, on the left side of the housing 5 in FIG. 3, to the valve side. To be more precise, the first exhaust gas passage 21 includes a flexion bent smoothly in an arc shape from the aperture portion of the first exhaust gas passage 21 to the first valve port 24. The first valve port 24 is opened in the valve room 31 having therein the plate valve 4 capable to open and close. The internal surface of the housing 5 includes the passage wall facing the EGR gas flow from the outlet portion of the EGR gas cooler 7 to the inside of the first exhaust gas passage 21. The passage wall of the housing 5 is a bent surface 32, whose curvature radius is provided. Accordingly, the EGR gas flows smoothly into the first valve port 24, without increasing the pressure loss of the EGR gas flowing from the outlet portion of the gas cooler 7 into the inside of the first exhaust gas passage 21.

The second exhaust gas passage 22 is the second passage extending from the aperture portion, on the left side of the housing 5 in FIG. 3, to the valve side. To be more precise, the second exhaust gas passage 22 includes a straight pipe portion 33 from the aperture portion of the second exhaust gas passage 22 to the second valve port 25. The second valve port 25 is opened in the valve room 31 having therein the plate valve 4 capable to open and close. The second exhaust gas passage 22 includes a flexion bent smoothly in an arc shape from the end of the straight pipe portion 33 to the valve side, that is, the second valve port 25 opened in the valve room 31. The internal surface of the housing 5 includes the passage wall facing the EGR gas flow from a bypass passage 46 to the inside of the second exhaust gas passage 22. The passage wall of the housing 5 is a bent surface 34, whose curvature radius is provided. The EGR gas flows smoothly to the second valve port 25, without increasing the pressure loss of the EGR gas flowing from the bypass passage 46 to the inside of the second exhaust gas passage 22. The straight pipe portion 33 disposed at the opposite side (aperture side) of the valve functions as a pipe-insertion hole in which a valve-side end of the bypass pipe 9 is inserted.

The low-temperature EGR gas is introduced from the first exhaust gas passage 21 into the valve room 31 through the first valve port 24, which is approximately circular. The high-temperature EGR gas is introduced from the second exhaust gas passage 22 into the valve room 31 through the second valve port 25, which is approximately circular. The valve room 31 is constructed with a three-way (Y-branch) pipe wall portion connecting the above-described three passages, the first, second and third exhaust gas passages 21-23. In the three-way pipe wall portion, a round shape first valve seat 28 is provided in the peripheral portion of the aperture portion of the first valve port 24. A round shape second valve seat 29 is provided in the edge of the aperture end (inside diameter surface) of the second valve port 25. The housing 5 in the embodiment includes a partition wall 35 for air-tightly partitioning the first exhaust gas passage 21 and the second exhaust gas passage 22 from each other. The partition wall 35 includes a cylindrical valve bearing 36 holding the valve shaft 6 in the rotation direction through a bearing part (not shown). A shaft sliding port in tight contact with the external surface of the shaft 6 is provided inside of the valve bearing 36. On the internal surface of the partition wall 35, a first stopper 37 and a second stopper 38 are provided. The first stopper 37 provides the position of the plate valve 4 in contact with the joint part connecting the valve portion 26 and the fixed end of the plate valve 4, as shown in FIG. 1. The second stopper 38 provides the position of the plate valve 4 in contact with the joint part connecting the valve portion 26 and the fixed end of the plate valve 4, as shown in FIG. 1.

The valve-driving device, which drives the plate valve 4, includes an actuator (not shown) utilizing negative pressure, a link feature (motion direction converting feature: not shown) converting a linear motion of the actuator to a rotational motion, and the shaft 6 transmitting the power of the actuator to the plate valve 4. The actuator displaces a diaphragm by controlling a pressure difference between an atmospheric pressure room and a negative pressure room constructed between a casing and the diaphragm by an electromagnetic or electric negative pressure control valve. Therefore, a rod interlocked with the diaphragm can be reciprocated in the axial direction. Accordingly, when the reciprocating displacement in the rod axial direction is transmitted to the shaft 6 through the link feature, the shaft 6 rotates by a predetermined angle.

The shaft 6 in the embodiment is held on the valve bearing 36 provided in the partition wall 35 of the housing 5 and can slide in the rotation direction through the bearing part. Likewise the plate valve 4, the shaft 6 is formed integrally of metal material having heat and corrosion resistance (e.g., stainless steel); and includes a valve holding portion holding and fixing the fixed end of the plate valve 4. In the embodiment, an oil seal (e.g., seal gum: not shown) can be loaded between the inner periphery of the valve bearing 36 in the housing 5 and the outer periphery of the shaft 6 in order to prevent grease from flowing out. The grease lubricates the bearing part of the valve bearing 36.

The actuator utilizing negative pressure is energized and controlled by an engine control unit (hereinafter referred to as “ECU”) 10. The ECU 10 is provided with a microcomputer, whose structure is universally known, including a CPU conducting control and calculation process, a memory device (e.g., memory like ROM or RAM) saving kinds of program and data, and functions like an input circuit and an output circuit. Further, the ECU 10 is constructed to control electronically the open degree of the plate valve 4 of the valve device based on the control program and a map 61 stored in the memory when a ignition switch (not shown) is turned ON (IG ON). When the ignition switch is turned OFF (IG OFF), above described control based on the control program stored in the memory of ECU 10 is terminated forcibly.

Sensor signals from all kinds of sensors are converted by an A/D converter and input into the internal microcomputer of the ECU 10. A crank angle sensor, an accelerator-opening sensor, an airflow meter and a coolant water temperature sensor are connected to the microcomputer. Further, an EGR sensor, an intake air temperature sensor 62, and an exhaust gas temperature sensor 63 are connected to the microcomputer. The EGR sensor detects the amount of EGR gas flowing in the exhaust gas recirculation pipe. The intake air temperature sensor (intake air temperature detecting device) 62 detects the temperature of the intake air (intake air temperature) flowing into the combustion room of engine 1. The exhaust gas temperature sensor (device detecting the temperature of exhaust gas) 63 detects the temperature of the EGR gas in the recirculation pipe 15 flowing from the EGR gas cooler module 3 to the air intake passage 12. At this moment, the exhaust gas temperature sensor 63 outputs a sensor signal (voltage signal) corresponding to the temperature of the EGR gas. The EGR gas flows through the exhaust gas recirculation passage in the exhaust gas recirculation pipe 15 from the outlet port of the valve room 31 of the housing 5.

The EGR gas cooler 7 constitutes the exhaust gas cooling device. Also, the bypass pipe 9 constitutes the exhaust gas cooling device in parallel with the EGR gas cooler 7. The EGR gas cooler 7 is a water-cooled heat exchanger, which cools the EGR gas to equal, or less than a predetermined temperature by exchanging heat. The heat of the high-temperature exhaust gas (EGR gas) introduced from the exhaust gas recirculation pipe 14 is exchanged with the low-temperature engine coolant water flowing from the coolant pipe 17. The EGR gas cooler 7 includes a rectangular casing 41 connected directly in series to the downstream end of the exhaust gas recirculation pipe 14 through a branch joint portion 8. The casing 41 is connected directly in series to the upstream end of the housing 5 of the valve device through a mounting flange 42. The casing 41 stores plural exhaust gas tubes 43 therein. The casing 41 includes a coolant water passage 44 in which the engine coolant water recirculates. The coolant water passage 44 is provided in the periphery of the plural exhaust gas tubes 43.

The casing 41 constructing the shell of the EGR gas cooler 7 is formed like a rectangular pipe by joining two press-formed “U”-letter shaped metal plates having heat and corrosion resistance (e.g., stainless steel). The plates are blazed by a blazing metal (e.g., copper) in a thickness direction. At the left end of the casing 41, shown in FIG. 3, a coolant water inlet pipe 16 is provided so that the engine coolant water flows from a water jacket of the engine 1 into the coolant water passage 44. At the right end of the casing 41, shown in FIG. 3, the coolant water outlet pipe 18 is provided so that the engine coolant water returnes from the coolant water passage 44 into the water jacket of the engine 1 through a radiator. The plural exhaust gas tubes 43 are flat pipes for introducing the EGR gas from the branch joint portion 8. The exhaust gas tubes 43 are built up several steps, between which a predetermined clearance exists in the minor axis direction. The exhaust gas tubes 43 extend over the entire length of the casing 41 in the major axis direction.

The mounting flange 42 is connected to the joint portion 30 of the housing 5 by blazing, fastening screw or caulking. The mounting flange 42, likewise the casing 41, includes a core plate formed by pressing the metal plates having heat and corrosion resistance (e.g., stainless steel) to produce a predetermined shape. On the core plate, square shaped mounting holes, whose number is the same as that of the exhaust gas tubes 43, are formed to connect the ends (shown as right end portions) of the plural exhaust gas tubes 43 in the axis direction. The tubes 43 are inserted to the holes and blazed. Further, a round-shaped inserting hole is formed to pass through the end of the bypass pipe 9 in the axis direction on the core plate. The mounting flange 42 can be formed integrally with the casing 41.

Each exhaust gas tube 43 is formed in a flat-tube shape. The exhaust gas tube 43, likewise the casing 41, constitutes a tubular heat exchanger by building up alternately plural press-formed “U”-letter shaped metal plates having heat and corrosion resistance (e.g., stainless steel). The plates are blazed by a blazing metal (e.g., copper) in a thickness direction. Inside of the plural exhaust gas tubes 43, an exhaust gas cooling passage 45 is formed. Inside of the exhaust gas cooling passage 45, a rectangular wave shaped inner fin (not shown) is provided in order to improve the heat exchange efficiency between the EGR gas and the engine coolant water by increasing the heat transmission area with the EGR gas. In the EGR gas cooler 7 in the embodiment, the flow direction of the engine coolant water and the flow direction of the EGR gas are the same (parallel flow) in order to improve the boiling water resistance of the engine coolant water flowing through the coolant water passage 44.

As above described, the branch joint portion 8 is connected to the upstream side of the EGR gas cooler 7 integrally to combine the EGR gas cooler 7 directly in series with the downstream end of the exhaust gas recirculation pipe 14. The mounting flange 42 is connected to the downstream side of the EGR gas cooler 7 integrally to combine the EGR gas cooler 7 directly in series with the upstream end of the housing 5. Between the branch joint portion 8 and the mounting flange 42, the bypass pipe 9 is disposed in parallel with the EGR gas cooler 7 adjacent to the EGR gas cooler 7. The EGR gas cooler 7, the bypass pipe 9, the branch joint portion 8 and the mounting flange 42, that is, the exhaust gas passages are exposed to the high-temperature EGR gas. The temperature of the EGR gas is equal or more than 400-500° C. The flocculated water of the EGR gas includes sulfides, nitric acid, sulfuric acid, ammonium ion, and acetic acid. Accordingly, the exhaust gas cooling device is manufactured integrally by joining and blazing metal material having heat and corrosion resistance (e.g., stainless steel).

The branch joint portion 8 includes a branch pipe, a tank plate and a core plate. The branch pipe branches the EGR gas introduced from the exhaust gas recirculation pipe 14 between the exhaust gas cooling passage 45 inside of the EGR gas cooler 7 and the bypass passage 46 inside of the bypass pipe 9. The branch joint portion 8 is combined directly to the upstream end of the casing 41 by blazing. The tank plate and the core plate, likewise the casing 41, are formed into a predetermined shape by connecting metal plates having heat and corrosion resistance (e.g., stainless steel), using a blazing metal (e.g., copper). Square shaped mounting holes, whose number is the same as that of the exhaust gas tubes 43, are formed in the core plate. The left ends (shown in FIG. 3) of the plural exhaust gas tubes 43 in the axis direction are inserted into the holes of the core plate and connected thereto by blazing. Further, a round shaped hole is formed for inserting an end of the bypass pipe 9 in the axis direction in the core plate.

An inner space (inlet side tank room) surrounded by the tank plate and the core plate functions as a two-way branch passage 47. The branch passage 47 branches the EGR gas introduced from the exhaust gas recirculation passage of the exhaust gas recirculation pipe 14 between the exhaust gas cooling passage 45 inside of the EGR gas cooler 7 and the bypass passage 46 inside of the bypass pipe 9 at a predetermined flow ratio (mixing ratio). Further, the two-way branch passage 47 functions as an inlet side tank of the EGR gas cooler 7. The two-way branch passage 47 provides the exhaust gas cooling passage 45 inside of the EGR gas cooler 7 with the all EGR gas introduced from the exhaust gas recirculation passage of the exhaust gas recirculation pipe 14. Moreover, the two-way branch passage 47 functions as the exhaust gas passage. The two-way branch passage 47 provides the bypass passage 46 inside of the bypass pipe 9 with the all EGR gas introduced from the exhaust gas recirculation passage of the exhaust gas recirculation pipe 14.

The length of the bypass pipe 9 in the embodiment is longer than that of the casing 41 of the EGR gas cooler 7 in the extending direction of the bypass pipe 9. The bypass pipe 9 is disposed in parallel with the EGR gas cooler. 7 and adjacent to (close to) the EGR gas cooler 7; and is an approximately cylindrical pipe (metal pipe) for introducing the EGR gas from the two-way branch passage 47. The bypass pipe 9, likewise the casing 41, is formed into a cylindrical pipe shape by connecting metal plates having heat and corrosion resistance (e.g., stainless steel), using a blazing metal (e.g., copper). Inside of the bypass pipe 9, the bypass passage 46 is formed in order to divert the EGR gas introduced from the branch passage 47, from the exhaust gas cooling passage 45 of the EGR gas cooler 7.

An end of the bypass pipe 9 in the axis direction is an aperture end 51 on inlet side of the bypass pipe. The aperture end 51 is connected to the core plate of the branch joint portion 8 by blazing. The aperture end 51 is inserted into the mounting hole formed on the core plate of the branch joint portion 8. Inside of the aperture end 51 of the branch joint portion 8, an inlet port (inlet port of the bypass passage 46) for introducing the EGR gas from the two-way branch passage 47 of the branch joint portion 8 is formed. Another end of the bypass pipe 9 in the axis direction is an aperture end 52 on outlet side of the bypass pipe 9. The aperture end 52 is inserted through the mounting hole formed on the core plate of the mounting flange 42 and is positioned adjacent to the valve in the housing 5. Inside of the aperture end 52 of the bypass pipe 9, an outlet port (outlet port of the bypass passage 46) for flowing out the EGR gas from the bypass passage 46 in the bypass pipe 9 into the flexion of the second exhaust gas passage 22 of the housing 5 is formed.

The bypass pipe 9 includes a cylindrical shaped fitting portion 53. The fitting portion 53 is inserted to the inside of the straight pipe portion 33 of the second exhaust gas passage 22. The second exhaust gas passage 22 has an aperture on the left side of the housing 5 in the valve device, shown in FIG. 3. Thus, above described aperture end 52 is provided at another end of the fitting portion 53. In the embodiment, the aperture end 52 of the fitting portion 53 of the bypass pipe 9 extends to a position adjacent to the valve (valve portion 26 of the plate valve 4) in the housing 5. Accordingly, the aperture end 52 of the fitting portion 53 of the bypass pipe 9 is inserted into the inside of the housing 5, and is positioned adjacent to the valve. In this case, the aperture end 52 of the fitting portion 53 of the bypass pipe 9 can extend in order to position more than extremely adjacent to the valve, provided the aperture end 52 does not interfere the valve portion 26 of the plate valve 4.

In the embodiment, the aperture end 52 of the fitting portion 53 of the bypass pipe 9 extends, and is inserted inside of the housing 5 in order to position adjacent to the valve bearing (valve bearing 36 of the housing 5) in the housing 5. In this case, the aperture end 52 of the fitting portion 53 of the bypass pipe 9 is preferred to position closer to the valve than the valve bearing 36 of the housing 5. The fitting portion 53 of the bypass pipe 9 and the inner surface of the straight pipe portion 33 of the second exhaust gas passage 22 (inner surface of the partition wall 35 of the housing 5) define a round space 54. The round space 54 is provided for decreasing the heat transmission from the flectional passage of the second exhaust gas passage 22 and the bypass passage 46 in the bypass pipe 9 to the EGR gas cooler 7. In case the fitting portion 53 of the bypass pipe 9 is fixed on the inner surface of the housing 5, the fitting portion 53 can be pressed and fitted in the inner surface of the housing 5 with a gasket interposed between the fitting portion 53 and the inner surface of the housing. The fitting portion 53 of the bypass pipe 9 can be fixed on the inner surface of the housing 5 by fixing means (e.g., welding). Heat insulating materials can be interposed in the round space 54.

Next, an operation of the gas circulating apparatus in the embodiment is described based on FIG. 1 or 3.

By turning over an engine 1 (e.g., diesel engine), an intake valve of an intake port formed on a cylinder head of the engine 1 is opened. Intake air, filtered through an air cleaner 13, is distributed to each intake manifold of a cylinder engine through an air intake passage 12, a throttle body and a surge tank. The intake air enters in each cylinder engine of the engine 1. At the engine 1, the air is compressed to have a high temperature, and a fuel having a high pressure is jetted to the air to be burned. Combustion can be made after high-pressure fuel injection. The combustion gas in each cylinder engine is emitted from an exhaust gas port formed on the cylinder head of the engine 1 through an exhaust manifold and an exhaust gas passage 11 of an exhaust gas pipe. At this time, an ECU 10 controls a current value of the negative pressure control valve so that a plate valve 4 of a valve device is opened by predetermined value (rotation angle). Then, a negative pressure is introduced to a negative pressure room. A diaphragm displaces corresponding to the pressure difference between the negative pressure room and an atmospheric pressure room; and a rod lifts by a predetermined value. A link feature works by accompanying the rod movement, and a shaft 6 rotates centering on a central axis.

Accordingly, the plate valve 4 is held with the desired valve opening (rotation angle). Thus, a first valve port 24 and a second valve port 25 are opened with desired aperture sections. The low-temperature EGR gas is introduced from each exhaust gas cooling passage 45 in the EGR gas cooler 7 to inside of a valve room 31 through a first exhaust gas passage 21 of a housing 5. The low-temperature EGR gas hits against an end surface of a valve portion 26 in a thickness direction of the plate valve 4 in the valve room 31. Afterward, the low-temperature EGR gas flows toward an outlet port of the valve room 31 and a third exhaust gas passage 23. The high-temperature EGR gas is introduced from a bypass passage 46 in a bypass pipe 9 to inside of the valve room 31 through a second exhaust gas passage 22 of the housing 5. The high-temperature EGR gas hits against another end surface of the valve portion 26 in a thickness direction of the plate valve 4 in the valve room 31 and flows toward the outlet port of the valve room 31 and the third exhaust gas passage 23. The high-temperature EGR gas is mixed with the low-temperature EGR gas there. On the other hand, a portion of the high-temperature EGR gas hits against another end surface of the valve portion 26 in a thickness direction of the plate valve 4 in the valve room 31. The portion of the high-temperature EGR gas does not flow toward the outlet port of the valve room 31 and the third exhaust gas passage 23. The portion of the high-temperature EGR gas hits against an opposite surface of a side wall 27 (inner surface of the housing 5). Thus, the portion of the high-temperature EGR gas changes the heading direction again and mixes with the low-temperature EGR gas, swirling toward the outlet port of the valve room 31 and the third exhaust gas passage 23. Accordingly, the temperature of the EGR gas recirculated from the exhaust gas recirculation pipe to the air intake passage 12 can be optimized.

In a stationary time, for example, the valve opening of the plate valve 4 (rotation angle: e.g., aperture section of the first valve port 24 or the second valve port 25) is controlled as shown by a full line in FIG. 1 or 3. The all of the EGR gas introduced from the exhaust gas recirculation pipe 14 into the inside of an EGR gas cooler module 3 is forced to flow through the EGR gas cooler 7. The EGR gas in a two-way branch passage 47 is forced to flow through each exhaust gas cooling passage 45, the first exhaust gas passage 21, the first valve port 24, the valve room 31, the third exhaust gas passage 23, and an exhaust gas cooling passage 15 to the air intake passage 12. The EGR gas is cooled adequately by engine coolant water while the EGR gas is flowing through each exhaust gas cooling passage 45 of plural exhaust gas tube 43 of the EGR gas cooler 7. The engine coolant water flows in a coolant water passage 44 of a casing 41 of an EGR gas cooler 7. Accordingly, the low-temperature and small-bulk EGR gas is mixed with an intake air. Therefore, NOx generation can be reduced effectively by lowering the combustion temperature without lowering an output of the engine 1.

On the other hand, in a cold circumstance, for example, the valve opening of the plate valve 4 (rotation angle: e.g., aperture section of the first valve port 24 or the second valve port 25) is controlled as shown by a chain double-dashed line in FIG. 1 or 3. The all of the EGR gas introduced from the exhaust gas recirculation pipe 14 into the inside of the EGR gas cooler module 3 is forced to flow through the bypass pipe 9. The EGR gas introduced into a two-way branch passage 47 is forced to flow through the bypass passage 46 in the bypass pipe 9, the second exhaust gas passage 22 of the housing 5, the second valve port 25, the valve room 31, the third exhaust gas passage 23 and the exhaust gas cooling passage 15 to the air intake passage 12. The EGR gas is recirculated with the EGR gas temperature being relatively high. Accordingly, an adequate warming effect on an intake air can be obtained so that a possibility of the ignition failure will be reduced and a generation of white fuming can be prevented. Further, lowering an intake air temperature by cooling the EGR gas causes a decrease of a NOx generation. However, if the engine 1 is operated in a condition that the revolution and the loading of the engine 1 are low relatively, an emission of particulate matters (PM) increases by cooling the EGR gas. Therefore, by controlling the valve opening (rotation angle) moderately, corresponding to the operating condition of the engine 1, the NOx emission and the PM emission can be reduced at the same time.

Next, an effect of the embodiment will be described.

In the EGR gas cooler module 3 constructed in the gas circulating apparatus in the embodiment, the valve device is disposed at the downstream side of the exhaust gas cooling device (i.e., EGR gas cooler 7 and bypass pipe 9) in the EGR gas flow. The valve device is constructed so that the EGR gas is introduced toward the valve room 31 through the second exhaust gas passage 22 from an aperture end 52 of a fitting portion 53 of the bypass pipe 9. In the EGR gas cooler module 3 in the embodiment, the aperture end 52 of the bypass pipe 9 extends adjacent to the valve. The aperture end 52 of the bypass pipe 9 is inserted to the housing 5 and is disposed adjacent to the valve.

Accordingly, the high-temperature EGR gas heat introduced from the aperture end 52 to the inside (flexion portion) of the second exhaust gas passage 22 is difficult to be transmitted to the first exhaust gas passage 21 from the second exhaust gas passage 22 through the partition wall 35. The partition wall defines the first and second exhaust gas passages 21, 22 of the housing 5. Thus, the high-temperature EGR gas heat introduced to the inside (flexion portion) of the second exhaust gas passage 22 is difficult to be transmitted to the first exhaust gas passage 21. That is, the transmission of the high-temperature EGR gas heat to the EGR gas cooler 7 can be reduced. Accordingly, the gas circulating apparatus is able to recirculate a desired high-temperature exhaust gas into an intake passage 12 of the engine 1 without reducing a cooling ability of the EGR gas cooler 7 or enlarging an aperture section of a bypass pipe 9.

The fitting portion 53 of the bypass pipe 9 and the inner surface of the straight pipe portion 33 of the second exhaust gas passage 22 (the inner surface of the partition wall 35 of the housing 5) define the round space 54. The round space 54 is provided in order to decrease the heat transmission from the bypass passage 46 and the second exhaust gas passage 22 to the first exhaust gas passage 21 of the EGR gas cooler 7. Accordingly, the heat of the high-temperature EGR gas flowing through inside of the bypass passage 46 of the bypass pipe 9 is difficult to be transmitted to the first exhaust gas passage 21 inside of the housing 5. Also, the high-temperature EGR gas heat introduced to the inside (flexion portion) of the second exhaust gas passage 22 from the aperture end 52 of the bypass pipe 9 is difficult to be transmitted to the first exhaust gas passage 21 inside of the housing 5. Thus, the transmission of the EGR gas heat to the EGR gas cooler 7 can be reduced more.

In the EGR gas cooler module 3 in the embodiment, the aperture end 52 of the fitting portion 53 of the bypass pipe 9 extends adjacent to the valve bearing portion. The aperture end 52 of the fitting portion 53 of the bypass pipe 9 is inserted inside of the housing 5 and is positioned adjacent to the valve bearing portion in the housing 5. Accordingly, the high-temperature EGR gas heat introduced to the second exhaust gas passage 22 from the aperture end 52 of the bypass pipe 9 is difficult to be transmitted to the valve bearing 36 from the second exhaust gas passage 22. Thus, the heat affect of the valve bearing 36 of the housing 5 can be reduced. Especially in a case an oil seal (e.g., seal gum) is provided between the inner periphery of the valve bearing 36 and the outer periphery of the shaft 6, the temperatures of the oil seal itself and the periphery of the oil seal are prevented from exceeding the allowable temperature limit of the oil seal. Thus, the thermal degradation of the oil seal by the high-temperature EGR gas heat can be reduced.

While the invention has been described with reference to a preferred embodiment thereof, it is to be understood that the invention is not limited to the preferred embodiments and constructions.

In the embodiment, an actuator including an electromagnetic or electric negative pressure control valve is used as a valve driving device which opens and closes the plate valve 4 of the valve device. An electric actuator provided with a power unit including a driving motor, a power transmission feature (e.g., mechanical reduction gear) or an electromagnetic actuator like an electromagnetic flow control valve may be used in place of the actuator used in the embodiment. In the embodiment, an actuator including an electromagnetic or electric negative pressure control valve is used as a valve driving device which opens and closes a valve of the EGR control valve 2. An electric actuator provided with a power unit including a driving motor, a power transmission feature (e.g., mechanical reduction gear) or an electromagnetic actuator like an electromagnetic flow control valve may be used in place of the actuator used in the embodiment. A biasing means (e.g., spring), which biases the plate valve 4 of the valve device in the opening or closing direction, may be provided for the valve driving device.

In the embodiment, although the rotating plate valve 4 centering the central axis of the shaft 6, is used as a valve, a butterfly valve, a poppet valve, a double-poppet valve or a rotary valve may be used as the valve. Although the EGR gas cooler 7 and the bypass pipe 9 are straight shaped pipes, flexion pipes can be used for the EGR gas cooler 7 and the bypass pipe 9. The EGR gas cooler 7 can be disposed apart from the housing 5 or the bypass pipe 9, and the EGR gas cooler 7 can be connected to the housing 5 through an exhaust gas recirculation pipe, provided the housing 5 and the bypass pipe 9 are integrated. The valve device can be used as an exhaust gas passage switching valve (three-way switching valve) or an exhaust gas mixing ratio control valve.

In the embodiment, the fitting portion 53 of the bypass pipe 9 is formed into a straight pipe shape corresponding to a straight pipe portion 33 of the second exhaust gas passage 22 of the housing 5. The fitting portion 53 of the bypass pipe 9 can be formed into a flexional pipe curving an arc smoothly from the aperture portion of the second exhaust gas passage 22 toward the second valve port 25 in the valve room 31. The fitting portion 53 of the bypass pipe 9 can be formed into a straight pipe extending toward a position adjacent to the valve and sloping against the center axis of the second valve port 25. Moreover, it is not necessarily the case that the fitting portion 53 of the bypass pipe 9 is inserted from the aperture portion of the second exhaust gas passage 22 of the housing 5. The aperture portion of the second exhaust gas passage 22 of the housing 5 can be blocked. An inserting hole, which is orthogonal or sloping against the axis direction of the second exhaust gas passage 22 of the housing 5, can be provided. The fitting portion 53 of the bypass pipe 9 can be inserted from the aperture portion of the inserting hole. Accordingly, the aperture end 52 of the bypass pipe 9 can be disposed to face to inside of the second exhaust gas passage 22 of the housing 5.

Such changes and modifications are to be understood as being within the scope of the present invention as defined by the appended claims.

What is claimed is:

1. A gas circulating apparatus for circulating exhaust gas of an internal combustion engine, the apparatus comprising:
a heat exchanger for cooling exhaust gas passing therethrough;
a bypass pipe through which exhaust gas flows while bypassing the heat exchanger; and
a valve device disposed downstream of the heat exchanger and the bypass pipe in an exhaust gas flow, wherein:
the valve device includes a housing which has a first exhaust gas passage communicating with an inside of the heat exchanger and a second exhaust gas passage communicating with an inside of the bypass pipe, and a valve provided inside of the housing, to open and close the first exhaust gas passage and the second exhaust gas passage;
the bypass pipe includes an aperture end from which the exhaust gas flows into the second exhaust gas passage; and
the aperture end is inserted into the inside of the housing, and is positioned adjacent to the valve.

2. The gas circulating apparatus according to claim 1, wherein:
the bypass pipe and a passage wall of the second exhaust gas passage define a round space for decreasing a heat transmit toward the first exhaust gas passage.

3. The gas circulating apparatus according to claim 1, wherein:
the valve device further includes a valve-driving member provided to open and close the valve; and
the valve-driving member includes a valve shaft rotating integrally with the valve.

4. The gas circulating apparatus according to claim 3, wherein:
the housing includes a valve bearing which holds the valve shaft in a rotation direction; and
the bypass pipe extends inside of the housing such that aperture end on an outlet side of the bypass pipe is located adjacent to the valve bearing.

5. The gas circulating apparatus according to claim 1, wherein:
the heat exchanger, the bypass pipe and the valve device are disposed in the exhaust gas recirculation pipe for recirculating a part of exhaust gas in the engine to an air intake side of the engine.

6. The gas circulating apparatus according to claim 1, wherein:
the housing includes a partition wall separating the first exhaust gas passage and the second exhaust gas passage from each other, a valve room provided at a downstream side of the partition wall in the exhaust gas flow, and a third exhaust gas passage through which the exhaust gas from the valve room is introduced to an air intake side of the engine; and
the valve room is connected to the first, second and third exhaust gas passages in a letter “Y” shape in section.

7. The gas circulating apparatus according to claim 1, wherein:
the bypass pipe extends in an extending direction, and the aperture end of the bypass pipe is positioned outside of the heat exchanger in the extending direction.

8. The gas circulating apparatus according to claim 7, wherein:
the bypass pipe is longer than a length of the heat exchanger in the extending direction.
